(19) United States
(12) Patent Application Publication
(10) Pub. No.: US 2020/0050795 A1
(43) Pub. Date: Feb. 13, 2020

(54) ASSOCIATING ANONYMIZED IDENTIFIERS WITH ADDRESSABLE ENDPOINTS

(71) Applicant: PebblePost, Inc., New York, NY (US)

(72) Inventors: Adam C. Solomon, East Setauket, NY (US); Lewis Gersh, New York, NY (US)

(21) Appl. No.: 16/539,997

(22) Filed: Aug. 13, 2019

Related U.S. Application Data
(60) Provisional application No. 62/718,260, filed on Aug. 13, 2018.

(51) Int. Cl. G06F 21/62; G06F 16/22; G06F 16/901

(52) U.S. Cl. CPC G06F 21/6254; G06F 21/6263; G06F 16/9024; G06F 16/2255

(57) ABSTRACT

A mail platform system accesses an identifier graph that links user identifiers to anonymized address identifiers linked to addressable endpoints. The mail platform system receives a first user identifier that identifies a user from an integration code included in a website accessed at a user device. The mail platform system determines that the first user identifier is associated with a second user identifier included in the identifier graph and identifies an address identifier linked to the second user identifier in the identifier graph. The mail platform system adds the first user identifier to the identifier graph and connects the first user identifier to the address identifier. The mail platform system determines to transmit a message to the user associated with the first user identifier based on activity information associated with the first user identifier, and retrieves an addressable endpoint based on the address identifier linked to the first user identifier.

### CROSS-REFERENCE TO RELATED APPLICATIONS

This application claims the benefit of U.S. Provisional Patent Application No. 62/718,260, filed Aug. 13, 2018, which is incorporated by reference in its entirely.

### BACKGROUND

Systems exist for identifying individual users in various online environments. For example, users may sign in to particular websites or apps, thus identifying themselves to the particular websites or apps. Some websites store cookies on users' devices that allow the websites to recognize users across multiple browsing sessions on the same browser or device. However, current methods for identifying users have limited success at matching users across multiple devices or browsers. Many websites allow users to browse content without signing in, so users that have registered with a website may still browse the website without identifying themselves to the websites. Furthermore, cookies have limited applicability to a particular browser or device. For example, a cookie stored on a user's computer when the user views a website is only stored on the computer; if the user later views the same website on a smartphone, the cookie is not loaded, and the website does not recognize the user.

### BRIEF DESCRIPTION OF THE DRAWINGS

FIG. 1 shows an architecture overview of a mail platform system for generating direct mail for sending to users, according to an embodiment.

FIG. 2 is a flowchart illustrating an example of a process of generating direct mail, according to an embodiment.

FIG. 3 is a block diagram illustrating an example of an identifier (ID) subsystem, according to an embodiment.

FIG. 4A illustrates a portion of an address graph stored by the ID subsystem, according to an embodiment.

FIG. 4B illustrates a portion of an ID graph stored by the ID subsystem, according to an embodiment.

FIG. 5 is a flowchart illustrating a process of adding brand identifiers to the ID graph, according to an embodiment.

FIG. 6A illustrates a portion of the ID graph including brand identifiers, according to an embodiment.

FIG. 6B illustrates the portion of the ID graph of shown in FIG. 6A with a learned connection between identifiers, according to an embodiment.

FIG. 7 is a block diagram showing a brand web site communicating ID information to the mail platform system, according to an embodiment.

FIG. 8 illustrates a portion of the ID graph including platform IDs communicated by the brand website, according to an embodiment.

FIG. 9 illustrates a portion of the ID graph including an additional brand ID associated with a platform ID, according to an embodiment.

FIG. 10 is a block diagram showing a brand website communicating with a vendor for providing a vendor ID to the mail platform system, according to an embodiment.

FIG. 11 illustrates the ID subsystem storing and using the vendor ID in the ID graph, according to an embodiment.

FIG. 12 is a high-level block diagram illustrating an example computer for implementing various elements described herein.

### DETAILED DESCRIPTION

The figures and the following description describe certain embodiments by way of illustration only. One skilled in the art will readily recognize from the following description that alternative embodiments of the structures and methods illustrated herein may be employed without departing from the principles illustrated herein. Reference will now be made in detail to several embodiments, examples of which are illustrated in the accompanying figures. It is noted that wherever practicable, similar or like reference numbers may be used in the figures to indicate similar or like functionality.

### Configuration Overview

The mail platform system disclosed herein overcomes the problems described above by matching and connecting user identifiers and activity across multiple contexts, e.g., across different websites, browsers, and devices. The mail platform system creates and maintains an identifier graph, or “ID graph,” that links different user identifiers that the mail platform system determines are associated with the same user. The user identifiers can include identifiers assigned by the mail platform system and identifiers used by various other entities, such as brand websites. The identifiers can also include identifiers derived from contact information, such as email addresses. The mail platform system learns user identifiers, and connections between user identifiers, based on information received directly from brands, from integration codes provided by the mail platform system and embedded into websites, from identity resolution services, or from other sources.

The mail platform system can also learn one or more addressable endpoints (e.g., postal addresses) for each user and connects address information to users in the ID graph. The mail platform may learn addresses based on postal address databases, consumer information received from brands, and based on learned connections between other user identifiers. The mail platform system can preserves user privacy and the security of user personally identifiable information (PII) by tracking and storing sensitive user information in an anonymized way (e.g., in a hashed and/or encrypted form). Addresses, names, and other PII of users are not stored in the ID graph. Instead, the mail platform system can represent the PII in the ID graph using anonymized (e.g. hashed and/or encrypted) identifiers, and store the addresses and other PII in one or more separate, secure databases to mitigate the impact of a subsequent data breach.

Using the ID graph to connect and store multiple user identifiers of different types associated with a single user increases the likelihood that the mail platform system can positively identify a user compared to prior methods, such as requiring users to sign in to websites, or relying on cookies. For example, if a user device browses a website that would not recognize a user (e.g., because the user device has not browsed that website before, or the user has not signed into the website), the integration code can transmit other user identifies (e.g., a platform identifier or an email address). The mail platform system can match the received identifier(s) to user identifier(s) in the ID graph and identify the user based on any of the identifiers included for the user in the ID graph. Thus, by creating an ID graph with various identifiers for a single user, the mail platform system can identify users that would otherwise be unknown to or misidentified by the mail platform system or the brand. By also associating the user identifiers with contact information of users, such as postal addresses, the mail platform system can generate direct mail for a user based on the user's activity that was tracked using one or more of the user identifiers.

In an embodiment, the mail platform system includes an address database, an identifier graph, and a processor executing program code. The address database is a database storing postal addresses and corresponding address identifiers. The identifier graph is a graph database that links each of the address identifiers to one or more user identifiers and, in some embodiments, other data, (for example demographic data). In some embodiments, the address identifiers representing postal addresses in the identifier graph are anonymized (e.g. hashed). Some of the user identifiers are external identifiers used outside the mail platform system, such as user identifiers assigned by brands. Other user identifiers are platform user identifiers assigned by the mail platform system or a third-party service provider. The program code executed by the processor includes instructions to receive a platform user identifier identifying a user of a user device that was transmitted by an integration code included in a website accessed at the user device. The processor determines that the received platform user identifier is associated with an external user identifier in the identifier graph, and identifies an address identifier linked to the external user identifier in the identifier graph. The processor adds the platform user identifier to the identifier graph, and generates a link in the identifier graph connecting the platform user identifier to the address identifier. The processor determines whether to address mail to the user associated with the platform user identifier based on activity information and/or other information associated with the platform user identifier, and in response to the determination, retrieves a postal address from the address database for mailing the user based on the address identifier linked to the platform user identifier.

In some embodiments, the mail platform system accesses an identifier graph that links address identifiers to user identifiers or other information about the user. Each address identifier is linked to one of a plurality of addressable endpoints and anonymizes in the identifier graph the linked addressable endpoint. The mail platform system receives, from a user device, a first user identifier that identifies a user of the user device. The first user identifier is transmitted based on an integration code included in a website accessed at the user device (e.g. the integration code may set an identifier, e.g., a cookie, in a browser of a user device). The mail platform system determines that the first user identifier identifying the user of the user device is associated with a second user identifier included in the identifier graph, identifies an address identifier linked to the second user identifier in the identifier graph, adds the first user identifier to the identifier graph, and generates a link in the identifier graph connecting the first user identifier to the address identifier. The mail platform system can then determine whether to transmit a message to the user associated with the first user identifier based on activity information and other information associated with the first user identifier, and retrieves an addressable endpoint to which to transmit the message based on the address identifier linked to the first user identifier.

### Direct Mailing System Overview

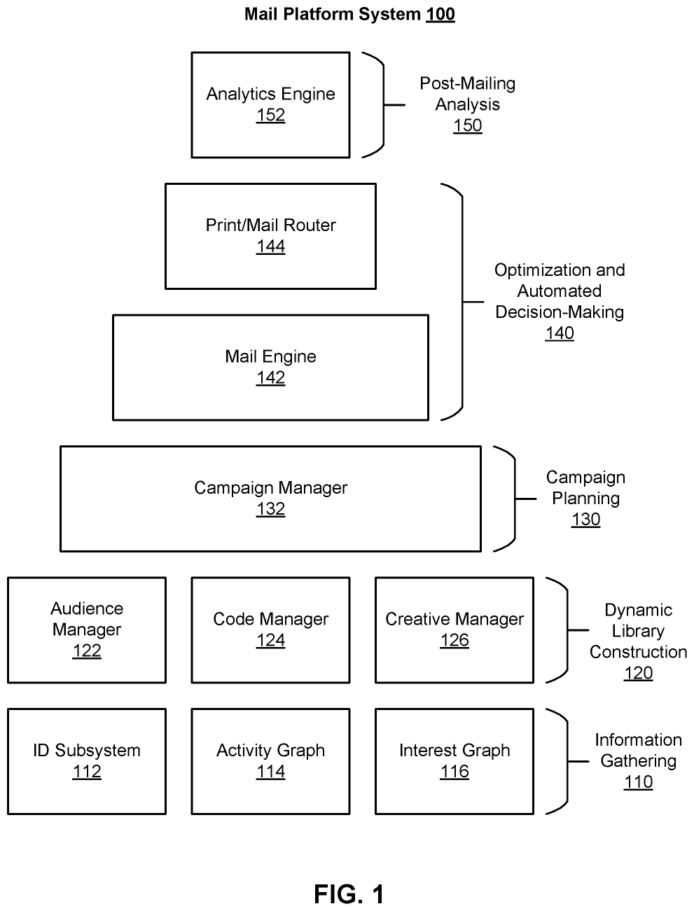

FIG. 1 shows an architecture overview of a mail platform system 100 for generating direct mail for sending to users, e.g., as part of a mailing campaign. As referred to herein, “users” are recipients or potential recipients of direct mail, such as an individual, a business, or another potential addressee of a mail item. Direct mailing campaigns are undertaken by the mail platform system 100 on behalf of entities referred to herein as “brands.” The mail platform system 100 includes various components that, working together, receive campaign goals and guidelines from brands, gather information about users, assemble mailing campaigns, identify optimal users to mail, generate and send mail to the identified users, analyze the performance of the campaigns, and report results of the campaigns to the brands.

The process of generating direct mail can be split into five main phases: (1) information gathering 110, (2) dynamic library construction 120, (3) campaign planning 130, (4) optimization and automated decision-making 140, and (5) post-mailing analysis 150. As shown in FIG. 1, each phase is performed by a module or group of modules; for example, an identification (ID) subsystem 112, activity graph 114, and interest graph 116 are involved in information gathering 110. In general, a mailing campaign will proceed sequentially through these five phrases, but in some implementations, multiple phases may be performed simultaneously, or the phases may be performed out of order.

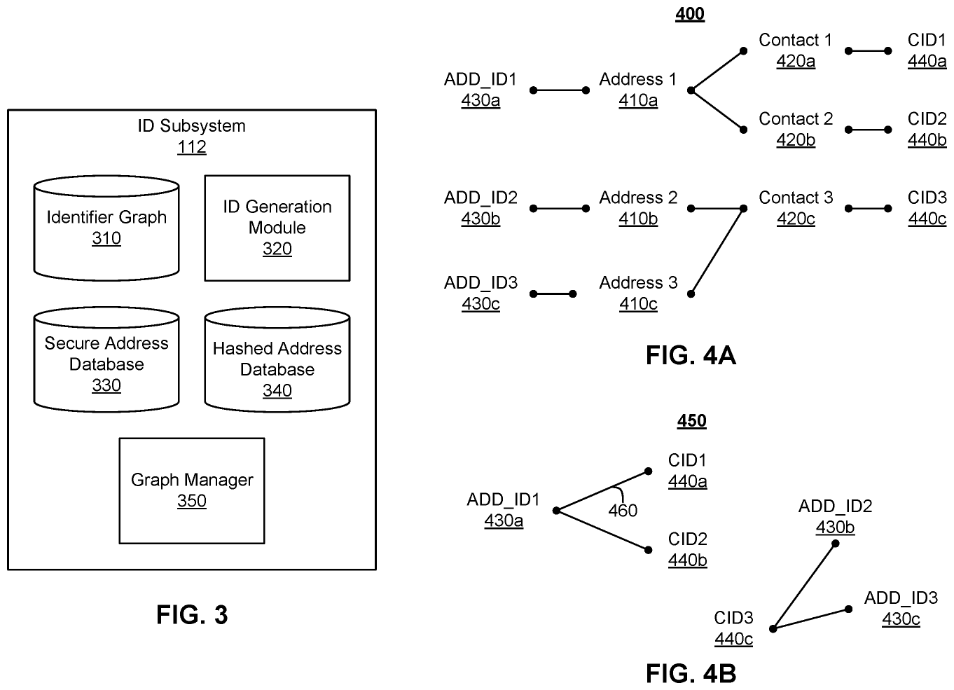

The information gathering phase 110 is performed by an ID subsystem 112, an activity graph 114, and an interest graph 116. The ID subsystem 112 is a secure, privacy centric system that, for each user known to the mail platform system 100, associates a user identifier for identifying the user within the mail platform system 100 (referred to herein as a “platform ID”) with contact information (e.g., address, email address, phone number) and other identifiers (e.g., brand user IDs, internet protocol (IP) addresses) of the user using a graph database. The ID subsystem 112 may store user PII in a secure encrypted database or external system which is only accessed by limited users (e.g. when retrieving full user postal addresses when addressing mail). The ID subsystem 112 may interact with one or more external databases that provide additional information about users, which can be accessed or imported by the ID subsystem 112. The ID subsystem 112 is described in further detail with respect to FIGS. 3-11.

The activity graph 114 is a secure, privacy centric repository of data describing activities of users, e.g., online browsing behavior and purchasing behavior. The activity graph 114 can incorporate both online and offline data. For example, integration codes provided by the mail platform system 100 can be incorporated into webpages and return information describing users' online activity. Brands can, in some embodiments, provide information describing offline activity, e.g., phone calls and in-store purchases.

The interest graph 116 can process the data about users in the activity graph 114 to learn about users' interests. The interest graph 116 may also incorporate demographic data and interests learned by other systems (e.g., brands or third parties). In some embodiments, the activity graph 113 and the interest graph 116 are unified into a single graph comprising information about user activities and interests.

The next phase, dynamic library construction 120, generates libraries that form the basis for mailing campaigns. The information in the libraries may be based on data collected during the information gathering phase 110 and additional information received from brands and other sources. Dynamic library construction 120 is performed by an audience manager 122, a code manager 124, and a creative manager 126.

The audience manager 122 constructs re-usable audience segments based on the information generated by the activity graph 114 and the interest graph 116. The audience manager 122 may also receive audience segments defined by brands, e.g., groups of users in consumer loyalty programs. Audiences defined by the audience manager 122 can be brand-specific or shared by multiple brands or all brands. The audience segments can be combined (e.g., at the campaign manager 130), e.g., using mathematical (e.g., Boolean) operators.

The code manager 124 stores codes that can be applied to the direct mailings, e.g., offer codes that can be used by users. The code manager 124 also stores rules for the codes (e.g., expiration date) so that the mail platform system 100 can automate allocation and selection of codes for direct mailings.

The creative manager 126 stores templates or visual or textual elements, such as images, logos, layouts, and/or text, which can be dynamically assembled to create mail designs. The creative manager 126 also stores metadata describing the templates or other creative elements. The creative manager 126 and/or the code manager 124 can store links between creative elements and offer codes; for example, a graphic that includes hearts and roses can be linked to an offer code for a Valentine's Day sale.

The campaign planning phase 130 generates mailing campaigns that utilize data from the dynamic libraries (the audience manager 122, code manager 124, and creative manager 126) using the campaign manager 132. The campaign manager 132 receives mailing campaign guidelines from a brand, such as goals, guidelines for targeting users (e.g., based on interests, geography, demographic information, etc.), timing, budget, etc. The campaign manager 132 may provide a graphical user interface that a brand representative can use to input options for a mailing campaign. The brand representative can generate campaigns that rely on codes stored in the code manager 124 and creative elements in the creative manager 126; in other embodiments, the brand representative inputs codes and/or creative elements using the campaign manager 132, which adds this data to the respective library 124 or 126.

After the campaign planning phase 130, the mail engine 142 and print/mail router 144 implement the mailing campaign in the optimization and automated decision-making phase 140. The mail engine 142 selects an optimal set of users to mail based on the campaign guidelines received by the campaign manager 132. The mail engine 142 selects and assembles the creative elements stored in the creative manager 126 to create a mail design file for each selected user. The mail engine 142 also retrieves the address for each user using the ID subsystem 112 and applies the addresses to their corresponding mail design files.

The mail/print router 144 determines a print vendor (e.g., an optimal print vendor) for each mail design file and user. The mail/print router 144 may select the print vendor based on the address of the user, the type of mail (e.g., postcard, catalog), target delivery date, cost, and any other factors. The mail/print router 144 can group the mail design files for each vendor into a single file (e.g., a PDF in which each page corresponds to a mail design for a particular user) that the print vendor can print and distribute.

After a mailing has been sent out, the post-mailing analysis phase 150 performs analytics on the campaign using the analytics engine 152. The analytics engine 152 gathers information on post-mailing activities of each mailed user or household and analyzes the success of the mailing campaign. The results of the analysis can be reported to or shared with the brand and used by the brand and/or the mail platform system 100 to improve the campaign strategies, targeting, and optimization of mailing campaigns.

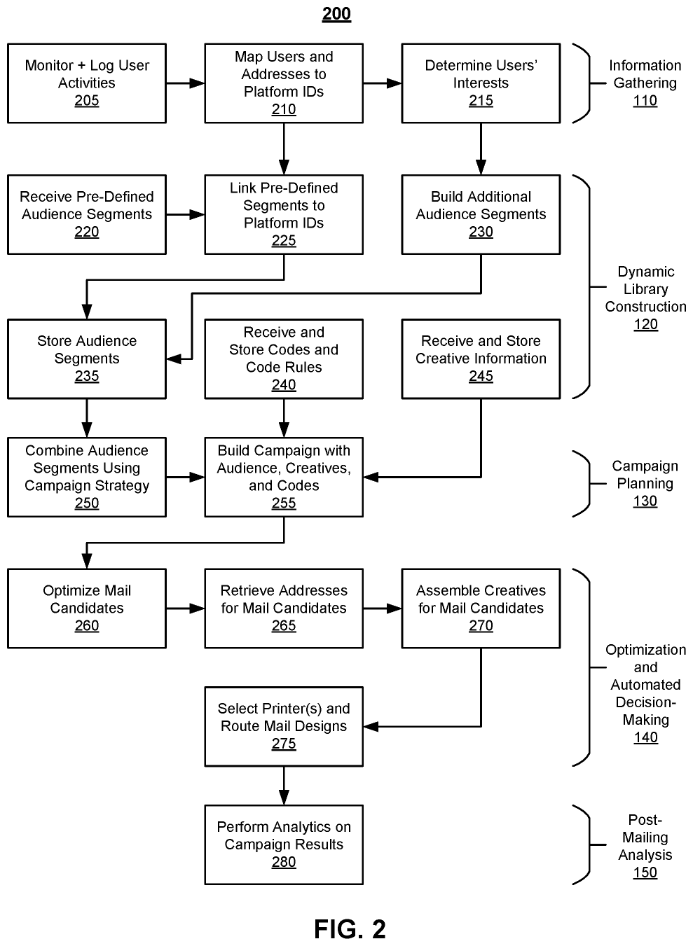

FIG. 2 is a flowchart illustrating an example of a process 200 of generating direct mail. The process 200 shows steps involved in each of the five phases shown in FIG. 1 (information gathering 110, dynamic library construction 120, campaign planning 130, optimization and automated decision-making 140, and post-mailing analysis 150). The steps of FIG. 2 can be performed by the modules shown in FIG. 1, as described below. In other embodiments, some or all of the steps may be performed by other modules. In addition, other embodiments may include different and/or additional steps, and the steps may be performed in different orders.

The activity graph 114 monitors and logs 205 user activities. For example, the activity graph 114 can receive information describing users' online browsing and purchasing behavior, e.g., from integration codes incorporated into webpages or cookies stored by browser software on a user device. The activity graph 114 associates activity information with an identifier of the user, such as a platform ID and stores the activity information in a secure, privacy centric data repository (e.g., hashed and/or encrypted) in a predefined format, e.g., representative of the activity graph 114.

The ID subsystem 112 maps 210 users and addresses to other identifiers, such as platform IDs (which can be generated by the mail platform system 100 or received from an external source). The mail platform system 100 receives personal information about users, such as names, addresses, email addresses, phone numbers, from one or more brands or for third parties. The mail platform system 100 may also receive brand-specific identifying information, such as brand IDs that the brand associates with users. The ID subsystem 112 selects or generates one or more platform IDs used to identify each user throughout the mail platform system 100, and securely stores PII of the user. When the mail platform system 100 generates mail, the ID subsystem 112 provides the mapped address for a platform ID based on the mapping 210.

The interest graph 116 determines 215 users' interests. The interest graph 116 may learn interests based on activities logged in the activity graph. For example, the interest graph 116 may analyze content of websites that a user visited to identify one or more categories associated with the websites (e.g., the interest graph 116 may determine that the user browsed 10 pages that involve shows based on URL patterns, image metadata, image analysis, website text, etc.). The interest graph 116 also may analyze searches conducted by the user, links that the user clicked, products purchased by the user, among other types of activity data. The interest graph 116 associates the learned interests with the platform IDs mapped at step 210.

The audience manager 122 can receive 220 pre-defined audience segments and dynamically generate 230 additional audience segments. For example, brands may provide audience segments, e.g., users that belong to a loyalty program, users that spend above a threshold amount per year, etc. As another example, a third party may provide demographic data about users (e.g., ages) which can be used to define audience segments (e.g., users aged 18-25, users aged 25-30, etc.).

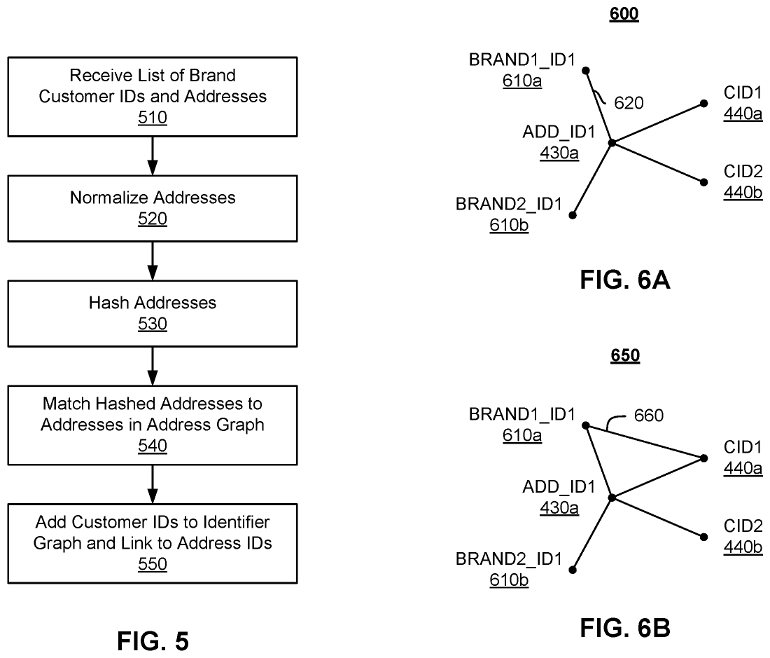

The audience manager 122 links the pre-defined user segments received at step 220 to the platform IDs mapped at step 210. As described above and further elaborated on with respect to FIG. 5, the mail platform system 100 can hash user data and compare the user data to data stored in the ID subsystem 112 to correlate received information about users to users included in the ID subsystem 112. The audience manager 122 can use a similar hashing process to link users included in the pre-defined and/or dynamically generated audience segments received from brands to the platform IDs used by the mail platform system 100.

In addition to receiving the pre-defined segments, the audience manager 122 can also build 230 additional audience segments using the interests determined at step 215. For example, the audience manager 122 may group all users who have demonstrated an interest in a particular product, e.g., sneakers, into an audience segment of users interested in sneakers.

The audience manager 122 stores 235 the audience segments received in step 220 and built in step 230 in a dynamic library. The dynamic library for the audience segment changes over time, e.g., as users show new interests, as the segmentation gets stale (e.g., as users age out of one age segment and into a new age segment), or as new users are added to the mail platform system 100.

The code manager 124 receives and stores 240 codes (e.g., offer codes) and code rules in a second dynamic library. The dynamic library for the codes also changes over time, e.g., as brands add new codes, and as codes expire or become stale.

The creative manager 126 receives and stores 245 creative information (e.g., texts and images assembled to create a mail design) in a third dynamic library. The dynamic library for the creative information also changes over time, e.g., as brands add text for new campaigns, or as brands remove old logos.

The campaign manager 132 combines 250 audience segments according to a campaign strategy provided by a brand. For example, if a brand wants to generate a campaign for a particular type of sneaker, the campaign manager 132 may combine multiple audience segments stored in step 235, e.g., an audience segment of users who like sneakers, and an audience segment of users who like the shoe brand. The campaign manager 132 can combine audience segments using mathematical (e.g. Boolean) operators, e.g., users (in the 18-25 age segment OR in the 25-30 age segment) AND who like sneakers. Combining the audience segments targets the mail sent according to particular goals, e.g., users who are most likely to purchase sneakers, or users who may be less likely to purchase sneakers but will be more likely to purchase sneakers if they receive the mail. The combined audience segments are candidates for mailing.

The campaign manager 132 also builds 255 the campaign using the mailing candidates identified at step 250 along with one or more codes stored at step 240 and creative information stored at step 245. For example, the campaign manager 132 may provide a user interface that a brand representative can use to select codes and creative information for a particular campaign, or rules for selecting codes or creative information, e.g., based on the user receiving the mail. In some embodiments, steps 250 and 255 may be performed in the opposite order, or in parallel.

The mail engine 142 optimizes 260 the mail candidates identified at step 250. For example, if the campaign has a set number of mailings that is smaller than the number of mail candidates, the mail engine 142 can select the users who are most likely to respond positively to the mailing based on one or more criteria learned by the mail platform system 100. In addition, the mail engine 142 may select a control group of users who will not be mailed (e.g. including one or more nonoptimized users).

The mail engine 142 retrieves 265 the addresses for the mail candidates who were selected for mailing at step 265. In some embodiments, the mail engine 142 retrieves the addresses from the secure address database of the ID subsystem 112 based on the platform ID associated with the selected mail candidates and used throughout the preceding steps. The mail engine 142 assembles 270 the creatives for the mail candidates by combining the user names, addresses, creative elements, and codes into a mail design, e.g., a PDF. The creative elements and codes are selected based on the campaign information provided at step 255.

The mail/print router 144 selects 275 one or more printers for the assembled mail and routes the mail designs to the selected printer(s). As described above, the mail/print router 144 may select the print vendor based on the address of the user, the type of mail, target delivery date, cost, or other factors.

After the mail is sent out, the analytics engine 150 performs analytics 280 on the campaign results. For example, the analytics engine 152 may compare the activities of the control group selected by the mail engine 142 to the mailed users to determine the success of the campaign. The analytics engine 150 can use the results of the analytics for various purposes, such as improving the optimization step 260, adding additional user activities to the activity graph 114, and, in some embodiments, providing reports or other feedback to the brands about the performance of the campaign.

### Example ID Subsystem

The ID subsystem 112 creates and maintains an ID graph that links identifiers that are associated with the same user. By connecting and storing multiple user identifiers for a single user, the ID subsystem 112 is able to recognize the same user across multiple browsers and multiple devices. The ID subsystem 112 is further able to associate user identifiers with contact information of the user, so that the mail platform system 100 can generate mail for a user based on the user's activity online or in other environments tracked using one or more of the user identifiers.

FIG. 3 is a block diagram illustrating an example of the identifier (ID) subsystem 112, according to an embodiment. The ID subsystem 112 includes an ID graph 310, an ID generation module 320, a secure address database 330, a hashed address database 340, and a graph manager 350. In other embodiments, the ID subsystem 112 may include additional, fewer, or alternative components from those shown in FIG. 3.

The identifier graph 310, also referred to as the ID graph 310, is a graph database that stores various user identifiers and connections between the user identifiers. A graph database is a database that stores data in a graph structure, which is made up of nodes and edges connecting the nodes. In the ID graph 310, various identifiers associated with users are stored in nodes, and connections between the identifiers are stored as edges. The identifiers stored in the ID graph 310 include identifiers that refer to particular users and identifiers that refer to user contact information. User identifiers stored in the ID graph 310 may include user identifiers assigned to users by different systems. The user identifiers can include internal identifiers, also referred to as platform identifiers, which are identifiers generated by the mail platform system 100 or components created by the mail platform system 100. For example, platform identifiers can be created by the ID subsystem 112 or by integration codes created by the mail platform system 100 and integrated into brand websites. The user identifiers also include external identifiers, which are identifiers generated by and received from any third party, including brands and identity resolution services. Contact information identifiers may include identifiers used to refer to names, addresses, email addresses, and phone numbers. In some embodiments, the ID subsystem 112 uses contact information identifiers to refer to the contact information, rather than storing the contact information directly in the ID graph 310. Each node may include the type of identifier (e.g., Brand ID for Brand X, address ID, etc.) and the identifier itself (e.g., an alpha and/or numeric identifier such as “23552688200”). In other embodiments, other types of user identifiers or contact information identifiers may be included in the ID graph 310.

The edges in the graph database, which represent connections between the identifiers, indicate learned associations between pairs of identifiers. For example, if the ID subsystem 112 learns that the user of a given email address lives at a given postal address, the ID subsystem 112 adds an edge between the node representing that email address and the node representing that address to the ID graph 310.

In some embodiments, the ID generation module 320 creates anonymized identifiers to represent the contact information in the ID graph 310. The ID subsystem 112 stores the contact information in a separate database, e.g., the secure address database 340. The ID generation module 320 may generate anonymized identifiers in any manner that obfuscates the underlying data. For example, the ID generation module 320 may create an anonymized identifier to represent an item of contact information by generating a random or pseudorandom string of numbers or characters or by selecting an unused anonymized identifier from a list of unused identifiers, etc. The ID generation module 320 may also generate hash values from contact information based on a hash function. The hashes can be used within the ID subsystem 112 as anonymized identifiers, or to assist with matching contact information received from various sources, as described with respect to FIG. 5. Storing anonymized identifiers that refer to a user's contact information in the ID graph 310, rather than storing the contact information itself in the ID graph 310, helps maintain user privacy and the security of user PII. If the security of the ID graph 310 is breached, an unauthorized individual cannot obtain PII of the user from the ID graph 310. Similarly, if any of the user identifiers include sensitive information or PII (e.g., if a brand uses users' email addresses as their brand IDs), the ID generation module 320 may generate anonymized user identifiers to represent the user identifiers in the ID graph 310, with the associations between the sensitive information and the anonymized identifiers stored separately. In other embodiments, the ID generation module 320 can use identifiers (such as brand IDs) to represent a contact in the ID graph 310.

The secure address database 330 securely stores a correlation between addresses address identifiers created to represent the addresses. The secure address database 330 may similarly store additional contact information about the user associated with the address, such as a name, business name, or phone number of the user. The secure address database 330 may be stored with a higher degree of security (e.g. encryption) than the identifier graph 310, because it includes PII (e.g. users' postal addresses). The secure address database 330 may be encrypted (and/or hashed) and accessed relatively infrequently; for example, if anonymized address identifiers and/or hashed addresses (e.g., addresses stored in the hashed address database 340) are used during the information gathering stage 110, then the secure address database 330 is not accessed until step 265 of FIG. 2, to retrieve full addresses for mail candidates. The secure address database 330 may be stored using a different server system and/or in a different physical location from the other components of the ID subsystem 112. Similarly, the secure address database 330 can be administered and/or secured by a third party and may supply full addresses to the mail platform system 100 on request (for example, if the secure address database 330 is administered by a third party address service). In some embodiments using a third party secure address database 330, the mail platform system 100 does not permanently store un-anonymized user addresses. For example, the secure address database 330 may be stored at the print/mail router 144, at a print vendor, or at a third party address service.

The hashed address database 340 is a database for storing a correlation between hashed addresses and address identifiers created to represent the addresses. The ID generation module 320 can, in some embodiments, generate hashes of the addresses in the secure address database 330 according to a hash function, and the hashed address database 340 stores the resulting hash values (referred to as “hashed addresses”). The hashed address database 340 may be a graph database, in which nodes are address identifiers and hashed addresses, and the edges connect address identifiers to hashed addresses. The hashed address database 340 may also include nodes for hashed contact information, e.g., names of residents, and edges that connect contact nodes to address nodes of addresses at which the contacts reside. Alternatively, other database structures may be used. The ID generation module 320 may normalize the addresses to a standardized, consistent format before hashing them and storing the hashed addresses, so that the hashed addresses can be matched to other hashed addresses, as described with respect to FIG. 5.

During the information gathering stage 110 of the mail generating process 200, the ID subsystem 112 may generally use address identifiers and hashed addresses, rather than non-hashed (“clean”) addresses, to determine connections between users. The information gathering stage 110 is constantly ingesting and manipulating data, which can cause it to be vulnerable to data breaches. Hashed addresses and anonymized identifiers are used in the information gathering stage 110 to obfuscate users' contact information, so that if the ID graph 310 and/or hashed address database 340 is breached, users' PII is not exposed. For example, as described further with respect to FIG. 5, the ID subsystem 112 may receive address information from brands, immediately transform the addresses provided by the brands to hashed addresses (and delete the received addresses), and compare the hashes of the addresses provided by the brand to hashed addresses stored in the hashed address database 340 to identify connections between brand data and data already stored in the ID graph 310. In some embodiments, the ID subsystem 112 includes one or more additional hashed and/or secure databases for storing correlations between other identifiers and the corresponding user or contact information. For example, the ID subsystem 112 may include hashed and/or secure email databases, phone number databases, brand identifier databases, etc. The ID subsystem 112 uses the hashed and/or anonymized identifiers to refer to any other PII associated with the user during the mail generating process 200.

The graph manager 350 manages the graph databases maintained by the ID subsystem 112, including the ID graph 310. The graph manager 350 adds nodes and connections to graph databases based on information received at the mail platform system 100. The graph manager 350 also manipulates data within a graph database, e.g., by adding connections between nodes, combining nodes together, removing connections, removing nodes, etc. The graph manager 350 may remove connections or nodes after learning that the information held in the connections or nodes is no longer current. For example, if the mail platform system 100 receives information indicating that a user has moved to a new address (e.g., in response to learning a new address for that user), the identifier graph 310 may remove the connection between the address identifier and user identifiers in the identifier graph 310. Additional examples of adding data to the graph database and manipulating data within the graph database are shown in FIGS. 4A, 4B, 6A, 6B, 8, 9, and 11.

In some embodiments, each node in a graph database is unique. In other embodiments, a graph database may have multiple nodes storing the same identifier (referred to as duplicate nodes); in such embodiments, the graph manager 350 may identify duplicate nodes and collapse them into a single unique node that includes all of the edges of the duplicate nodes.

In some embodiments, the ID subsystem 112 includes multiple ID graphs 310 associated with different brands or groups of brands. Some brands may agree to have the mail platform subsystem 100 to share information learned about users with other brands. In this case, the same identifier graph 310 includes data from the brands that are sharing learned data. For example, the ID subsystem 112 may include a connection between a platform identifier and a brand identifier, and a connection between an address identifier and the same brand identifier. Based on these connections, the graph manager 350 learns that the platform identifier and the address identifier are connected. If the brand associated with the brand identifier has agreed to share information with a set of brands, the identifier graph 310 associated with all of the brands includes this learned connection between the address identifier and the platform identifier. If the brand associated with the brand identifier has not agreed to share information with other brands, then other identifier graphs in the ID subsystem 112 may not include the connection between the platform identifier and the address identifier.

### Example Address Graph

FIG. 4A illustrates a portion 400 of an address graph (e.g., the hashed address database 340) generated by the ID subsystem 112, according to an embodiment. In some implementations, the ID subsystem 112 ingests a postal address database that includes street addresses for a population of users to obtain a base set of contact and address information for the population. For example, a US postal address database may include street addresses for a large portion (e.g., at least 80%) of the population of the United States. The postal address database may be a relational database that relates street addresses to contacts who reside at each address, identified by, for example, name, birthdate, or phone number. The ID subsystem 112 may ingest similar data for businesses or other potential contacts, or for other geographic areas.

In this embodiment, the graph manager 350 stores the addresses as address nodes 410 in the address graph database. The graph manager 350 also stores the ingested contact information as contact nodes 420 in the address graph database. The contact nodes 420 may include contacts' names and any other information for identifying the contact. The portion 400 of the address graph shown in FIG. 4A includes three addresses (address 1 410a, address 2 410b, and address 3 410c) and three contacts (contact 1 420a, contact 2 420b, and contact 3 420c). Address 1 410a is connected by two edges to two contacts, contact 1 420a and contact 2 420b. This indicates that contact 1 420a and contact 2 420b both reside at address 1 410a. Contact 3 420c is connected by two edges to two addresses, address 2 410b and address 3 410b. This indicates that contact 3 420c is known to reside at two addresses (e.g., a primary home and a vacation home).

The ID generation module 320 generates anonymized address IDs, referred to as ADD_IDs 430, and anonymized contact IDs, referred to as CIDs 440. The graph manager 350 adds these identifiers 430 and 440 to the address graph database as nodes, and generates edges that represent the correspondence between ADD_IDs 430 and addresses 410, and between CIDs 440 and contacts 420. For example, ADD_ID1 430a corresponds to address 1 410a, as indicated by the edge connecting ADD_ID1 430a and address 1 410a. The ADD_IDs 430 and CIDs 440 are strings of characters that cannot be reverse engineered to determine the address or contact information without access to the address graph database.

As described above, the ID subsystem 112 may store hashed addresses separately from the clean addresses. In this embodiment, the addresses 410 may be hashed and stored in the hashed address database 340, while the clean addresses 410 are stored separately in the secure address database 330. Similarly, the contacts 420 may be hashed and stored in the hashed address database 340 or a separate hashed database, and the clean contact information may be stored in the secure address database 330 or a separate secure database.

### Example ID Graph

FIG. 4B illustrates a portion 450 of an ID graph (e.g., ID graph 310) stored by the ID subsystem 112, according to an embodiment. The portion 450 of the ID graph shown includes nodes for the ADD_IDs 430, and the CIDs 440, and does not include nodes for the addresses 410 or the contacts 420. The graph manager 350 creates edges in the ID graph that directly connect the ADD_IDs 430 to corresponding CIDs 440; these edges are based on the edges between the addresses 410 and the contacts 420 in the address graph to which the ADD_IDs 430 and CIDs 440 correspond. For example, edge 460 directly connects ADD_ID1 430a, which represents address 1 410a, to CID1 440a, which represents contact 1 420a.

The ADD_IDs 430 and CIDs 440, and the edges between them, form the basis of the ID graph 310. The ID subsystem 112 adds additional nodes and edges to the ID graph 310 based on additional information learned about users, including information received from brands, and information learned from user behavior. For example, brands may upload data they have generated or collected on their consumers to the mail platform system 100. The ID subsystem 112 can match the received brand data to the data in the ID graph 310 and add some or all of the received brand data to the ID graph 310.

FIG. 5 is a flowchart illustrating an exemplary process of adding brand identifiers to the ID graph, according to an embodiment. In this example, the ID subsystem 112 receives 510 a list of brand user IDs and addresses. The brand user IDs (also referred to as brand IDs) are identifiers that the brand uses to refer to users within the brand's system. The brand users may be current, previous, or potential consumers. For example, a brand may assign each unique consumer a random string of digits used to refer to the consumer. The brand learns and associates other user data, such as postal address, email address, phone number, etc. with each brand ID, e.g., when a consumer places an order with the brand. While the example shown in FIG. 5 refers to brand IDs and postal addresses, it should be understood that a similar process can be undertaken for other types of user data.

Having received the list of brand IDs and addresses, the ID subsystem 112 (e.g., the ID generation module 320) normalizes 520 the addresses. The hashed addresses in the hashed address database 340 are also normalized prior to hashing, as noted with respect to FIG. 3. Normalizing addresses transforms them to a standardized format so the addresses, and the hashes of the addresses, may be more easily be matched. For example, the address “123 W. Main St. #12, West Village, Calif. 12345” may refer to the same physical location as “123 West Main Street Apartment 12, Village, Calif. 12345-6789.” However, hashing these two addresses provides different results. So that the hashes of these two addresses match, an address normalizer normalizes the addresses received by the ID subsystem 112; for example, both of the example addresses may be normalized as “123 W MAIN ST. APT 12, VILLAGE, Calif., 12345-6789.” The address normalizer may be a module within the ID generation module 320 or the ID subsystem 112, or the ID subsystem 112 may access an address normalizing service that performs address normalizing.

After the received brand addresses are normalized, the ID generation module 320 hashes 530 the normalized addresses, for example, by sending the normalized addresses to a third party system and receiving hashed (and/or encrypted) versions of the addresses from the third party system. The ID generation module 320 uses the same hash function that it uses for the addresses in the hashed address database 340. The hash function is collision resistant, meaning that each unique input address results in a unique hash value, and two different input addresses to the hash function cannot produce the same hash value.

The graph manager 350 matches 540 the hashes of the addresses received from the brand to the hashed addresses in the hashed address database 340. In particular, for each hash of an address received from the brand, the graph manager 350 can search the hashed address database 340 for a matching hashed address. If the graph manager 350 finds a matching hashed address, the graph manager 350 retrieves the address ID that in the hashed address database 340 that is linked to the hashed address.

The graph manager 350 adds 550 the brand user ID as a node in the ID graph 310, and creates an edge linking the brand user ID to the retrieved address ID in the ID graph 310. An example of adding brand IDs to the ID graph is shown in FIGS. 6A and 6B. If additional information is received from the brand (e.g., email address), this information, or hashes or anonymized identifiers corresponding to this information, may be added to the ID graph 310 in a similar manner.

Because the hashed address database 340 is pre-populated with addresses, as described with respect to FIG. 4A, the graph manager 350 often finds a matching address. However, if the graph manager 350 does not find a matching address (e.g., in embodiments in which the hashed address database 340 is not pre-populated with addresses, or if the address of the consumer is missing from the hashed address database 340), the ID generation module 320 may generate an address ID for the hashed address received from the brand. The graph manager 350 then adds the hashed address and the generated address ID to the hashed address database 340, adds the clean address received from the brand to the secure address database 330, and adds the address ID and the brand ID to the ID graph 310.

FIG. 6A illustrates a portion 600 of the ID graph 310 that includes brand identifiers. The portion 600 includes two brand IDs, BRAND1_ID1 610a and BRAND2_ID1 610b, which correspond to two different brands, Brand 1 and Brand 2. Both BRAND1_ID1 610a and BRAND2_ID1 610b are connected to the same address identifier, ADD_ID1 430a; for example, BRAND1_ID1 610a is connected to ADD_ID1 430a by edge 620. The brand IDs may have been added to the ID graph 310 using the process shown in FIG. 5. As was shown in FIG. 4B, ADD_ID1 430a is connected to two contact IDs, CID1 440a and CID2 440b.

The graph manager 350 can learn connections between nodes in the ID graph 310 based on existing connections within the ID graph. For example, FIG. 6B illustrates a portion 650 of the ID graph of shown in FIG. 6A with a learned connection 660 between two identifiers. The graph manager 350 may determine to connect BRAND1_ID1 610a and CID1 440a with a new edge 660 because BRAND1_ID1 610a and CID1 440a are connected to the same address ID, ADD_ID1 430a. In this embodiment, two CIDs, CID1 440a and CID2 440b, are both associated with ADD_ID1 430a. To determine which of these two CIDs to connect BRAND1_ID1 to, the graph manager 350 may compare additional information received from the brand, such as the consumer's name, to contact ID information associated with the CIDs to determine to connect BRAND1_ID1 610a to CID1 440a, rather than to CID2 440b. In another embodiment, if ADD_ID1 430a is connected to CID1 440a and not to any other CIDs, the graph manager 350 may determine to connect BRAND1_ID1 610a to CID1 440a without referring to other contact information, because no other CIDs are associated with ADD_ID 430a.

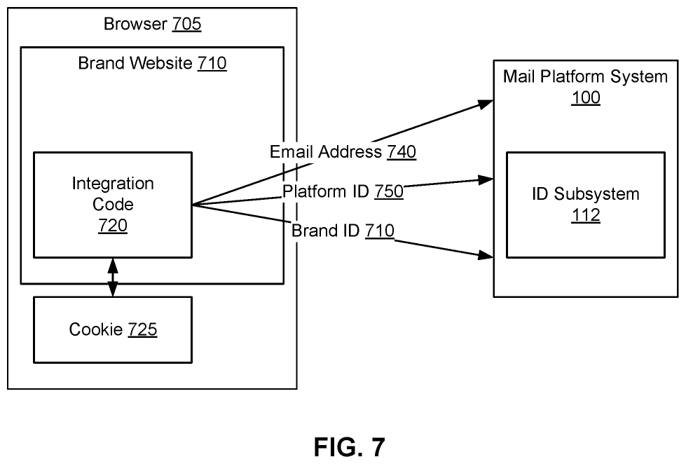

FIG. 7 is a block diagram showing a brand website 710 on a user's browser 705 communicating ID information to the mail platform system 100, according to an embodiment. As described with respect to FIG. 1, the mail platform system 100 can provide integration codes, such as integration code 720, to participating brands, and the brands incorporate the integration code 720 into their websites, such as brand website 710. The integration code 720 transmits information describing users' online browsing and purchasing behavior in the brand website 710. The integration code 720 is also configured to transmit available information for identifying the user that is browsing the brand website 710. In some embodiments, the integration code 720 sets a cookie 725 on a browser of the user device which stores and/or transmits some or all of the ID information sent to the mail platform system from the user device. For example, as shown in FIG. 7, the integration code 720 transmits an email address 740, a platform ID 750, and a brand ID 710 to the mail platform system 100. Similarly, the integration code 720 can set a cookie 725 storing a platform ID 750 or other relevant information gathered by the integration code 720. The integration code 720 may transmit the user identifying data to the mail platform system 100 in a single packet. The mail platform system 100 provides the received identifiers to the ID subsystem 112. In alternative embodiments, a previously stored cookie 725 can transmit stored information to the mail platform system 100 (for example, via the integration code 720).

The email address 740 is simply the user's email address. The ID subsystem 112 may use the email address 740 to identify a user in the ID graph 310 based on the email address 740, e.g., by looking up an identifier created by the ID generation module 320 to refer to the email address 340 (e.g., a hash and/or encrypted version of the email address 740), and finding this identifier in the ID graph 310.

The platform ID 750 is an identifier used by the mail platform system 100 to refer to a user. The integration code 720 may obtain a platform ID 750 stored locally on the user's device (for example, in a previously set cookie 725) and transmit the platform ID 750 to the mail platform system 100. If no stored platform ID is available, the integration code 720 generates a new platform ID 750 for a user, transmits the new platform ID 750 to the mail platform system 100, and locally stores the platform ID 750 on the user's device, e.g., in a cookie. The platform ID 750 may also be associated with activity of the user transmitted by the integration code 720 to the mail platform system 100. The mail platform system 100 may use one or more platform IDs 750 to identify to a particular user throughout the mail generation process 200.

The brand ID 710 is similar to the brand IDs 610 described with respect to FIG. 6. The brand ID 710 is an example of an external user identifier, which an external system (here, the system of the brand that provides the brand website 710) uses to identify a user. The email address 740 may also be considered an external identifier, since it identifies the user in contexts outside of the mail platform system 100. The integration code 720 may transmit fewer, additional, or alternative identifiers to the mail platform system 100. For example, the integration code 720 may try to obtain all identifiers of a given set of identifiers, and the integration code 720 transmits the identifiers in that set that it is able to obtain.

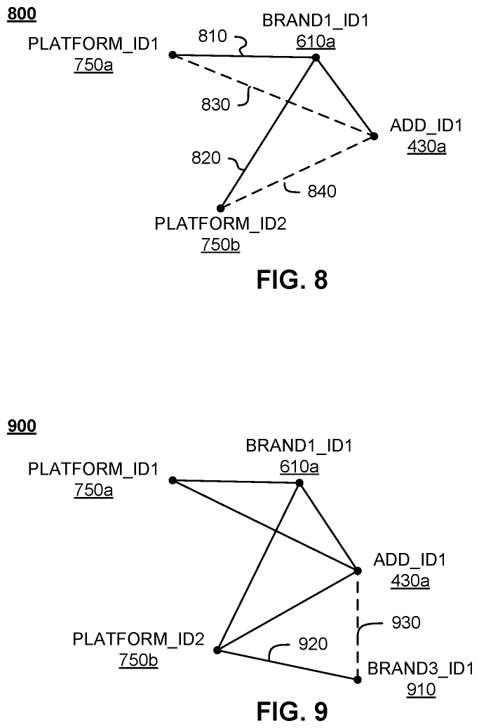

When the ID subsystem 112 receives the platform identifier 750 and various external user identifiers, the graph manager 350 matches the received identifiers to identifiers included in the ID graph 310. For example, if the brand ID 710 exists in the ID graph 310, the graph manager 350 may determine that the platform ID 750 received with the brand ID 710 is associated with the brand ID 710 in the ID graph 310, and add the platform ID 750 to the ID graph 310 with an edge connecting the platform ID 750 to the brand ID 710. The graph manager 350 also may link the platform ID 750 to other identifiers connected to the brand ID 710, such as an address ID already connected to the brand ID 710 (e.g., based on the brand information processed according to the steps shown in FIG. 5). The mail platform system 100 may rely on these data connections when addressing mail to users. For example, if the mail platform system 100 determines to address mail to the user associated with the platform ID 750 based on activity of the user, which is also tracked with the platform ID 750, the mail platform system 100 retrieves the postal address associated with the address ID connected to the platform ID 750. Additional examples of adding identifiers to the ID graph 310 and making connections in the ID graph 310 based on data received from an integration code 720 are described with respect to FIGS. 8 and 9.

As noted above, the integration code 720 can store the platform ID 750 in a particular identifier, e.g., a cookie 725 on the user's device. Because the integration code 720 is provided by the mail platform system 100, which is a third party relative to the brand website 710, the integration code 720 stores a third party cookie. In some embodiments, the browser accessing the brand website 710 does not store persistent third party cookies, so the integration code 720 generates a new platform ID 750 for each browsing session, or each time the browser accesses a different website or webpage. The brand website 710 may store a user identifier, e.g., the brand ID 740, in a first party cookie. The browser may store persistent first party cookies, so that each time the user accesses the brand website 710 in the browser, the integration code 720 can obtain the same brand ID 740.

FIG. 8 illustrates a portion 800 of the ID graph 310 including platform IDs communicated by the brand website, according to an embodiment. This portion 800 includes BRAND1_ID1 610a and ADD_ID1 430a, which were shown in FIG. 6A. The portion also includes two platform IDs, PLATFORM_ID1 750a and PLATFORM_ID2 750b, which are examples of the platform ID 750 shown in FIG. 7. In this example, the mail platform system 100 receives PLATFORM_ID1 750a and BRAND1_ID1 610a from the integration code 720 during one browsing session, and PLATFORM_ID2 750b and BRAND1_ID1 610a from the integration code 720 during a second browser session. In this example, the browser stores persistent first party cookies for the brand website 710, but does not store persistent third party cookies. Thus, the integration code 720 retrieves the same brand ID, BRAND1_ID1 610a, across the two sessions, and generates a new platform ID for each session.

Because PLATFORM_ID1 750a and PLATFORM_ID2 750b are both transmitted with BRAND1_ID1 610a, the graph manager 350 adds both of these platform IDs to the ID graph 310 with edges 810 and 820 connecting PLATFORM_ID1 750a and PLATFORM_ID2 750b, respectively, to BRAND1_ID1 610a. In addition, the graph manager 350 learns to connect PLATFORM_ID1 750a and PLATFORM_ID2 750b to ADD_ID1 430a because ADD_ID1 430a is connected to BRAND1_ID1 610a. These learned connections are shown as edges 830 and 840.

In some embodiments, a platform identifier is persistently stored on a user's device as the user browses multiple websites (e.g. via an identifier such as the cookie 725), which allows the ID subsystem 112 to learn connections across multiple websites based on a single platform ID. FIG. 9 illustrates a portion 900 of the ID graph 310 that shows an additional brand ID associated with a known platform ID. In this embodiment, two brand websites include the integration code 720. When the user device browses from a first website (e.g., a website having the integration code that generated PLATFORM_ID2 750b) to the second website, the second integration code accesses the previously-generated and stored platform ID, PLATFORM_ID2 750b. The second integration code transmits PLATFORM_ID2 750b along with a brand ID for the second website, BRAND3_ID1 900, to the mail platform system 100. The graph manager 350 creates a node for the BRAND3_ID1 910 and connects this node to PLATFORM_ID2 750b with edge 920. In addition, the graph manager 350 learns an additional connection 930 between BRAND3_ID1 910 and ADD_ID1 430a, because both BRAND3_ID1 910 and ADD_ID1 430a are connected to PLATFORM_ID2 750. In this embodiment, Brand 3 may not have had an address for the user identified by BRAND3_ID1 910, and thus the mail platform system 100 could not have provided direct mail from Brand 3 to this user. By using the PLATFORM_ID2 750b to track the user across websites, the ID subsystem 112 is able to learn an address for BRAND3_ID1 910, and can direct mail from Brand 3 to this user.

The number of platform IDs generated for a given user between many browsing sessions and multiple devices can become large. The graph manager 350 can modify the ID graph 310 by, for example, removing platform IDs that are no longer needed, collapsing multiple platform IDs into a single, current ID, learning to ignore platform IDs, etc. The graph manager 350 can similarly prune other identifiers in the ID graph 310 that have become unnecessary or stale to make the graph ID 310 more manageable.

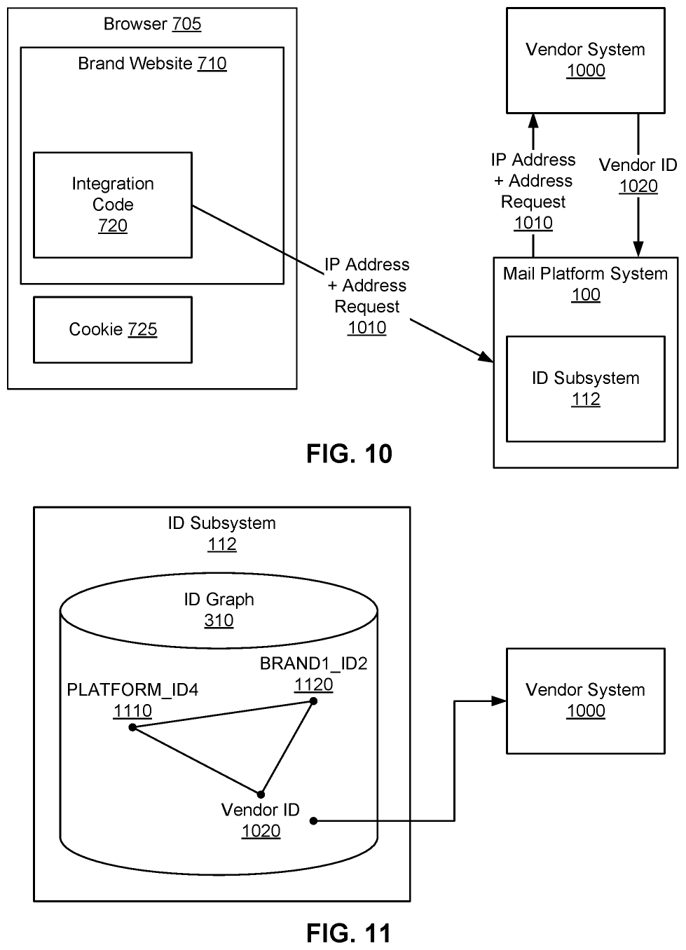

In some embodiments, the mail platform system 100 may use an identity resolution service or other vendor to assist with providing addresses or other information about users. FIG. 10 is a block diagram showing the mail platform system 100 communicating with a vendor for providing a vendor ID to the mail platform system 100 based on user information (e.g. an IP address) gathered based on a user's interaction with a brand website 710, according to an embodiment. The vendor ID may be an identifier used by a vendor system 1000 to look up an address or other information associated with a user.

In this example, the integration code 720 included in the brand website 710 transmits the IP address and an address request 1010 to a vendor system 1000. The IP address and address request 1010 can be transmitted directly to the vendor system 1000 from the integration code 720, or first transmitted to the mail platform system 100 and relayed by the mail platform system 100 to the vendor system 1000 (as shown in FIG. 10). The IP address is the IP address of the device browsing the brand website 710, which allows the vendor system 1000 to identify the user of the device. In other embodiments, the integration code 720 may provide additional or alternative information to the vendor system 1000 with the address request, e.g. an email address or brand ID. The address request is a request to the vendor system 1000 to provide information to the mail platform system 100 to obtain the address of the user of the device browsing the brand website 710. In some embodiments, the vendor system 1000 provides the address directly to the mail platform system 100 in response to the address request 1010. In other embodiments, such as the example shown in FIG. 10, the vendor system 1000 provides an identifier, vendor ID 1020, that the mail platform system 100 can use to look up the address from the vendor 1000. In alternate embodiments, the integration code 720 may request additional or alternative information about the user, and the vendor ID 1020 may allow the mail platform system 100 to look up additional or alternative information about the user, e.g., name, email address, phone number, etc.

FIG. 11 illustrates an example of the ID subsystem 112 storing and using the vendor ID in the ID graph 310. As shown in FIG. 11, the graph manager 350 stores the received vendor ID 1020 in the ID graph 310 with edges to other identifiers for the same user, in this case, PLATFORM_ID4 1110 and BRAND1_ID2 1120. The integration code 720 may transmit one of these identifiers to the vendor system 1000 with the address request 1010, and the vendor system 1000 may provide the identifier with the vendor ID 1020 so that the graph manager 350 can add connections between the vendor ID 1020 and other identifiers for the same user in the ID graph 310. In other embodiments, the graph manager 350 may determine connections to the vendor ID 1020 in other ways, e.g., by matching a timestamp or identifier of the address request 1010 received from the vendor system 1000 to a timestamp or identifier of the transmission of the identifiers 710, 740, and 750 shown in FIG. 7.

The ID subsystem 112 can request information about the user associated with the vendor ID 1020 from the vendor system 1000 by providing the vendor ID 1020 to the vendor system 1000, as indicated by the arrow from the vendor ID 1020 to the vendor system 1000 in FIG. 11. For example, the ID subsystem 112 may request the address associated with the vendor ID 1020 from the vendor system 1000. In another example, the vendor system 1000 may allow the mail platform system 100 to request a block of addresses (e.g., 50 or 100 addresses) associated with a set of vendor IDs; by receiving addresses in blocks, rather than one at a time, the mail platform system 100 cannot discern a one-to-one correlation between the addresses and the vendor IDs. In other embodiments, the vendor system 1000 can provide other information to the mail platform system 100 to supplement or confirm information in the ID graph 310. For example, the vendor system 1000 can provide other types of contact information (e.g., phone number, email address, etc.) of a user.

While the above described examples are generally directed to associating postal addresses with other user identifiers and generating physical mail to send to the postal addresses, in other embodiments, the techniques described herein can be applied to any addressable endpoints, including email addresses, phone numbers, etc.

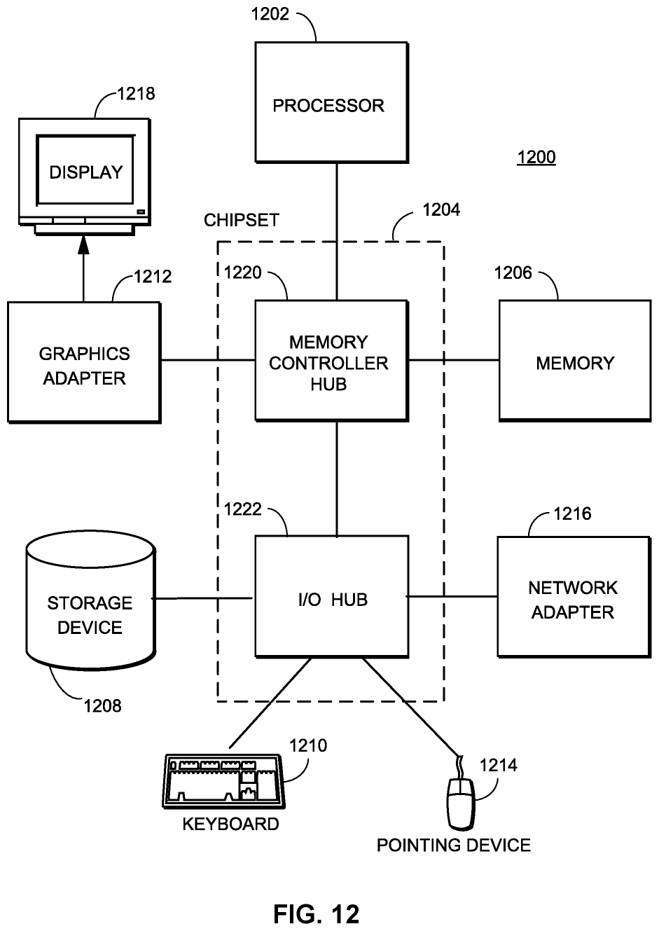

FIG. 12 is a high-level block diagram illustrating an example computer 1200 for implementing any of the elements of FIG. 1, the ID subsystem 112 or any of its elements shown in FIG. 3, and/or the vendor system 1000. The computer 1200 includes at least one processor 1202 coupled to a chipset 1204. The chipset 1204 includes a memory controller hub 1220 and an input/output (I/O) controller hub 1222. A memory 1206 and a graphics adapter 1212 are coupled to the memory controller hub 1220, and a display 1218 is coupled to the graphics adapter 1212. A storage device 1208, an input device 1214, and network adapter 1216 are coupled to the I/O controller hub 1222. Other embodiments of the computer 1200 have different architectures.

The storage device 1208 is a non-transitory computer-readable storage medium such as a hard drive, compact disk read-only memory (CD-ROM), DVD, or a solid-state memory device. The memory 1206 holds software or program code (e.g., comprised of one or more instructions) and data used by the processor 1202. The input interface 1214 is a touch-screen interface, a mouse, track ball, or other type of pointing device, a keyboard, or some combination thereof, and is used to input data into the computer 1200. In some embodiments, the computer 1200 may be configured to receive input (e.g., commands) from the input interface 1214 via gestures from the user. The graphics adapter 1212 displays images and other information on the display 1218. The network adapter 1216 couples the computer 1200 to one or more computer networks.

The computer 1200 is adapted to execute computer program modules for providing functionality described herein. As used herein, the term “module” refers to computer program logic used to provide the specified functionality. Thus, a module can be implemented in hardware, firmware, and/or software (or program code). In one embodiment, program modules are stored on the storage device 1208, loaded into the memory 1206, and executed by the processor 1202.

The types of computers 1200 used by the entities of FIG. 1 can vary depending upon the embodiment and the processing power required by the entity. The computers 1200 can lack some of the components described above, such as graphics adapters 1212, and displays 1218. For example, mail platform system 100 and any of its component subsystems can each be formed of multiple blade servers communicating through a network such as in a server farm.

### ADDITIONAL CONSIDERATIONS

The embodiments presented above offer multiple advantages over prior methods for recognizing users and tracking user activity. As described, the mail platform system matches user identifiers from various sources and maintains connections between the user identifiers in the ID graph. By maintaining and referencing the ID graph, the mail platform system is able to recognize users across more situations than previously possible, including matching a single user across multiple websites, browsers, and devices. By also learning and storing connections between user identifiers and addresses in the ID graph, the mail platform system is able to direct mail to users based on the activity that the mail platform system associates with the users. By using anonymized identifiers to refer to users in the ID graph, rather than the addresses themselves, the mail platform system is able to maintain this data in a way that secures user's data and reduces the likelihood that unauthorized users can access users' PII.

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs encoded on one or more computer readable storage mediums comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for selecting content based on correlations between preferred media features and specific configurations of environmental information. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

What is claimed is:

1. A mail platform system comprising:
an address database storing a plurality of postal addresses;
an identifier graph that links each of a plurality of address identifiers to one or more of a plurality of user identifiers, wherein a portion of the plurality of user identifiers are external user identifiers, and each address identifier is associated with one of the plurality of postal addresses stored in the address database and anonymizes in the identifier graph the associated postal address; and
a computer readable storage medium comprising program code encoded thereon that, when executed by at least one processor, causes the processor to:
receive a platform user identifier that identifies a user of a user device, the platform user identifier transmitted based on an integration code included in a website accessed at the user device;
determine that the received platform user identifier identifying the user of the user device is associated with an external user identifier in the identifier graph;
identify an address identifier linked to the external user identifier in the identifier graph;
add the platform user identifier to the identifier graph;
generate a link in the identifier graph connecting the platform user identifier to the address identifier;
determine whether to address mail to the user associated with the platform user identifier based on activity information associated with the platform user identifier; and
retrieve a postal address from the address database for mailing the user based on the address identifier linked to the platform user identifier.

2. The system of claim 1, wherein the computer readable storage medium further comprises program code encoded thereon that, when executed, causes the processor to:
hash each of the plurality of postal addresses in the address database according to a hash function to generate a first plurality of hashed addresses;
receive a plurality of external user identifiers and a second plurality of postal addresses, each postal address in the second plurality of postal addresses corresponding to one of the plurality of external user identifiers;
hash each of the second plurality of postal addresses according to the hash function to generate a second plurality of hashed addresses; and
for each of the external user identifiers:
match the hashed address corresponding to the external user identifier to one of the first plurality of hashed addresses; and
link the external user identifier to the address identifier linked to the matching one of the hashed addresses in the first plurality of hashed addresses.

3. The system of claim 2, wherein the computer readable storage medium further comprises program code encoded thereon that, when executed, causes the processor to:
normalize each postal address in the plurality of postal addresses prior to hashing each of the plurality of postal addresses to generate the first plurality of hashed addresses; and
normalize each postal address in the second plurality of postal addresses prior to hashing each of the second plurality of postal addresses to generate the second plurality of hashed addresses.

4. The system of claim 1, wherein the computer readable storage medium further comprises program code encoded thereon that, when executed, causes the processor to:
receive the platform user identifier and a second external user identifier based on code included in a second website accessed at the user device, wherein the second external user identifier is not linked to an address identifier of the plurality of address identifiers;
link the second external user identifier to the platform user identifier in the identifier graph; and
link the second external user identifier to the address identifier based on the link connecting the platform user identifier to the address identifier.

5. The system of claim 1, wherein the computer readable storage medium further comprises program code encoded thereon that, when executed, causes the processor to receive a vendor identifier associated with the platform user identifier, the vendor identifier provided by a vendor based on the code included in the website.

6. The system of claim 1, wherein the integration code is configured to transmit to the system at least one of the platform user identifier of the user of the user device, the external user identifier of the user of the user device, and an email address of the user of the user device.

7. The system of claim 6, wherein the integration code is further configured to:
store a third party cookie with a browser of the user device; and
transmit the platform user identifier in response to user activity on the website and in response to user activity on a second website.

8. The system of claim 1, wherein the integration code is further configured to transmit the platform user identifier and the external user identifier in a single packet.

9. A computer implemented method comprising:
accessing an identifier graph that links address identifiers to user identifiers, wherein each address identifier is linked to one of a plurality of addressable endpoints and anonymizes in the identifier graph the linked addressable endpoint;
receiving, from a user device, a first user identifier that identifies a user of the user device, the first user identifier transmitted based on an integration code included in a website accessed at the user device;
determining that the first user identifier identifying the user of the user device is associated with a second user identifier included in the identifier graph;
identifying an address identifier linked to the second user identifier in the identifier graph;
adding the first user identifier to the identifier graph;
generating a link in the identifier graph connecting the first user identifier to the address identifier;
determining whether to transmit a message to the user associated with the first user identifier based on activity information associated with the first user identifier; and
retrieving an addressable endpoint to which to transmit the message based on the address identifier linked to the first user identifier.

10. The method of claim 9, wherein the first user identifier is a different type of identifier from the second user identifier.

11. The method of claim 9, further comprising:
hashing each of the plurality of addressable endpoints according to a hash function to generate a first plurality of hashed addresses;
receiving a plurality of user identifiers and a second plurality of addressable endpoints, each addressable endpoint in the second plurality of addressable endpoints corresponding to one of the plurality of user identifiers;
hashing each of the second plurality of addressable endpoints according to the hash function to generate a second plurality of hashed addresses; and
for each of the user identifiers:
matching the hashed address corresponding to the user identifier to one of the first plurality of hashed addresses; and
linking the user identifier to the address identifier linked to the matching one of the hashed addresses in the first plurality of hashed addresses.

12. The method of claim 9, further comprising:
receiving the first user identifier and a third user identifier included in the identifier graph based on a second integration code included in a second website accessed at the user device, wherein the third user identifier is not linked to an address identifier in the identifier graph;
linking the third user identifier to the first user identifier in the identifier graph; and
linking the third user identifier to the address identifier based on the link connecting the first user identifier to the address identifier.

13. The method of claim 9, further comprising:
storing a third party cookie with a browser of the user device, the third party cookie including the first user identifier; and
in response to detecting activity on a second website, transmitting the first user identifier stored in the third party cookie.

14. The method of claim 9, further comprising:
storing the hashed addresses and address identifiers in a first database; and
encrypting and storing the addressable endpoints in a second database.

15. A computer readable storage medium comprising program code encoded thereon that, when executed by at least one processor, causes the processor to:
access an identifier graph that links address identifiers to user identifiers, wherein each address identifier is linked to one of a plurality of addressable endpoints and anonymizes in the identifier graph the linked addressable endpoint;
receive, from a user device, a first user identifier that identifies a user of the user device, the first user identifier transmitted based on an integration code included in a website accessed at the user device;
determine that the first user identifier identifying the user of the user device is associated with a second user identifier included in the identifier graph;
identify an address identifier linked to the second user identifier in the identifier graph;
add the first user identifier to the identifier graph;
generate a link in the identifier graph connecting the first user identifier to the address identifier;
determine to transmit a message to the user associated with the first user identifier based on activity information associated with the first user identifier; and
retrieve an addressable endpoint to which to transmit the message based on the address identifier linked to the first user identifier.

16. The computer readable storage medium of claim 15, wherein the first user identifier is a different type of identifier from the second user identifier.

17. The computer readable storage medium of claim 15, the program code further causing the processor to:
hash each of the plurality of addressable endpoints according to a hash function to generate a first plurality of hashed addresses;
receive a plurality of user identifiers and a second plurality of addressable endpoints, each addressable endpoint in the second plurality of addressable endpoints corresponding to one of the plurality of user identifiers;
hash each of the second plurality of addressable endpoints according to the hash function to generate a second plurality of hashed addresses; and
for each of the user identifiers:
match the hashed address corresponding to the user identifier to one of the first plurality of hashed addresses; and
link the user identifier to the address identifier linked to the matching one of the hashed addresses in the first plurality of hashed addresses.

18. The computer readable storage medium of claim 15, the program code further causing the processor to:
receive the first user identifier and a third user identifier included in the identifier graph based on a second code included in a second website accessed at the user device, wherein the third user identifier is not linked to an address identifier in the identifier graph;
link the third user identifier to the first user identifier in the identifier graph; and
link the third user identifier to the address identifier based on the link connecting the first user identifier to the address identifier.

19. The computer readable storage medium of claim 15, wherein the integration code is configured to:
store a third party cookie with a browser of the user device, the third party cookie including the first user identifier; and
in response to detecting activity on a second website, transmit the first user identifier stored in the third party cookie.

20. The computer readable storage medium of claim 15, the program code further causing the processor to:
store the hashed addresses and address identifiers in a first database; and
encrypt and store the addressable endpoints in a second database.
